(19) United States
(12) Patent Application Publication
(10) Pub. No.: US 2004/0226141 A1
(43) Pub. Date: Nov. 18, 2004

(54) Reversible door handle

(75) Inventors: Gaylon Yates, Parsons, TN (US); Gary B. Swtish, Racine, WI (US); Burl Finkelstein, Newnan, GA (US); Daniel John Delay, Muskego, WI (US)

Correspondence Address: BRINKS HOFER GILSON & LIONE, P.O. BOX 10395, CHICAGO, IL, 60610, US

(73) Assignee: Manitowoc Foodservice Companies, Inc.

(21) Appl. No.: 10/437,327

(22) Filed: May 13, 2003

(51) Int. Cl. B62B 1/00

(52) U.S. Cl. 16/412

(57) ABSTRACT

A reversible handle for a door having left and right door edges includes a grip generally perpendicular to the left and right door edges and spanning between two handle coupling members. The grip is reversibly positionable in proximity to either of the left or right door edges. A handle extension is coupled to the grip by a connector plate that couples a first end of the handle extension to an adjacent one of the two handle coupling members. The connector plate is configured to couple the handle for use with either a left-hand or right-hand door. The handle extension extends away from the connector plate in a direction generally opposite the grip and couples with a door hinge on the opposite side of the door. The grip is symmetrically configured, such that the grip can be positioned for left-hand or right-hand door opening without turning the handle on the door surface.

### TECHNICAL BACKGROUND

The invention relates, generally, to door handles for food chilling and freezing compartments and, more specifically, to handles for use with walk-in refrigerators or freezing units.

### BACKGROUND

A wide variety of door handle configurations are used in appliances, such as refrigerators, freezers, and the like. Typically, these handles include a base member that is connected to the door and a decorative cover attached to the base member to enhance the appearance of the handle. Refrigerator door handles of this type are described, for example, in U.S. Pat. No. 4,745,656 to Revlett, U.S. Pat. No. 5,659,927 to Shanok et al., U.S. Pat. No. 3,995,349 to Roberts et al., and U.S. Pat. No. 5,412,839 to McCollom.

Generally, the door handles described in the references noted above include decorative inserts and other styling features to improve the overall appearance of common appliances, such as refrigerators and the like. The decorative inserts are intended to cover the bases of the handle, which are typically constructed of cast or stamped metals and mechanically fixed to the front of the refrigerator door. To enhance the decorative appearance, the door handles typically include handle extensions to provide a smooth or flowing design.

Although advances in fabrication technology have enabled the construction of a variety of decorative handles for appliances, handles for heavier doors, such at that found on walk-in coolers and freezers, and the like, are typically heavy-duty door latch assemblies. These handles are typically fabricated from cast metal assemblies and are functionally attached to the door latching mechanism. Because of their functional nature, these handles typically lack the distinctive decorative styling of home appliance handles. While crude door latch assemblies are useful for unlatching and opening relatively heavy freezer compartment doors, advances in door fabrication technology and design now enable large compartment doors to operate in a manner similar to a conventional refrigerator. That is, magnetic door closures have been developed that effectively latch a relatively large door used for a walk-in cooler.

Accordingly, there is a need for improved styling in door handles that can take advantage of advances in door fabrication technology and improve the overall appearance of doors used with walk-in coolers and refrigerators, and the like. Additionally, there is a need for door handles having a decorative, non-symmetrical shape that can be easily adapted to either a right-hand or left-hand door using the same components and have the same appearance on the door regardless of the position of the handle, while maintaining the non-symmetrical feature.

### BRIEF SUMMARY

In accordance with the invention there is provided a reversible handle for a left-hand or right-hand door. The handle includes a grip reversibly positionable on the door for either left-hand or right-hand door operation, a handle extension, and a connector plate coupling a first end of the handle extension to the grip. The grip also includes a member having similar structures at each end thereof for coupling the connector plate to either end of the grip.

In another aspect, the invention includes a reversible handle for a door having left and right door edges. The handle includes a grip generally perpendicular to the left and right door edges and a grasping member spanning between two handle coupling members. The grip is reversibly positionable in proximity to either the left or right door edges. A connector plate connects an adjacent one of the two handle coupling members to a handle extension. The handle extension extends away from the connector plate in a direction generally opposite the grip and couples with a door hinge.

In yet another aspect, the invention includes a reversible door pull handle for walk-in cooler. The pull handle includes an elongated grip extending in a first direction on the door. An elongated handle extension traverses the door in a first direction. A bifurcated mounting bracket is configured to position the elongated grip in either a first handle location or a second handle location. The mounting bracket includes a first tongue engaging the elongated handle extension, a second tongue coupled to the elongated grip, and a third tongue coupled to the door. The second handle location is along the first direction and on a side of the door opposite to the first handle location.

In a still further aspect, the invention includes in combination, a door handle mounted on a door of a food-chilling compartment, the door handle comprising a grip and a handle extension that form a continuous lateral member across a face surface of the door, the lateral member having upper and lower edges that are a constant distance apart across the face surface of the door and wherein the grip bends in a first direction away from the face surface of the door and in a second direction toward an upper edge of door.

In a more particular aspect of the invention, the door handle can be configured such that the grip and extension have the same appearance on the door regardless of whether the grip in located near a left edge of the door or a right edge of the door.

### BRIEF DESCRIPTION OF THE DRAWINGS

FIG. 1 is a perspective view of a walk-in cooler having a door and a reversible door handle configured in accordance with the invention;

FIG. 2 is a perspective view of a walk-in cooler having the door and the reversible door handle of FIG. 1, but oriented in a reversed position;

FIG. 3 is a partial plain view of the reversible door handle shown in FIGS. 1 and 2;

FIG. 4 is a partial side view of the reversible door handle illustrated in FIG. 3;

FIG. 5 is a partial exploded side view of the reversible door handle of FIG. 3;

FIG. 6 is a perspective view of the mounting bracket used in the reversible door handle of FIG. 3;

FIG. 7 is an end view of a handle extension used in the reversible door handle of FIG. 3;

FIG. 8 is an end perspective view of the cover plate used in the reversible door handle of FIG. 3;

FIG. 9 is a cross-sectional view of the handle grip used in the reversible door handle of FIG. 3 taken along section line IX-IX of FIG. 3;

FIG. 10 is a top view of a casting used in the reversible door handle of FIG. 3; and

FIG. 11 is a partial cross-sectional view of a handle grip and door lock assembly used in the reversible door handle of FIG. 3 mounted on a door.

### DETAILED DESCRIPTION OF THE DRAWINGS AND THE PRESENTLY PREFERRED EMBODIMENTS

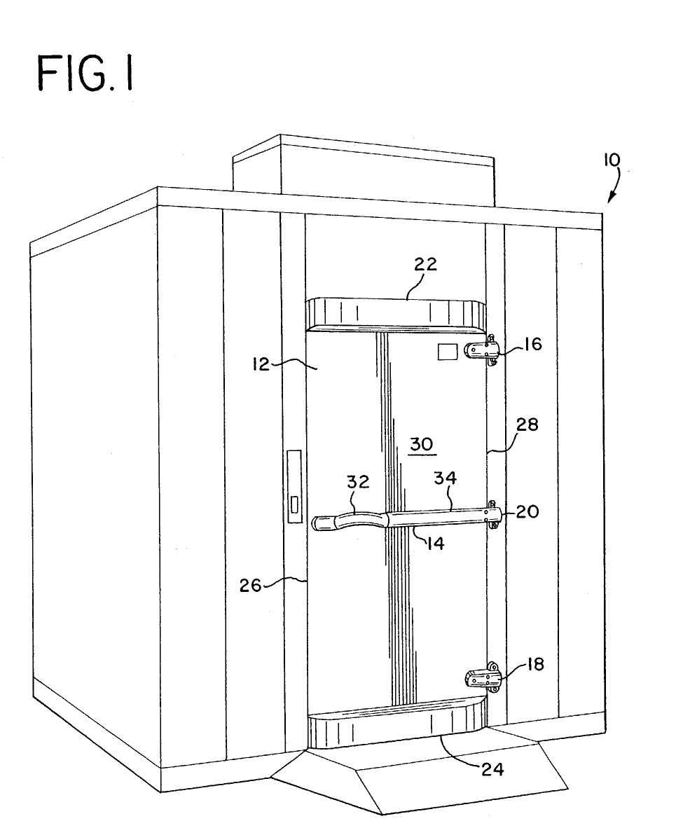

FIG. 1 illustrates a perspective view of a walk-in cooler 10 having a door 12 and a preferred reversible handle 14 of the present invention. Door 12 closes an opening into walk-in cooler 10 and is attached to walk-in cooler 10 by upper and lower hinges 16 and 18, respectively, and by a center hinge 20. Door 12 remains closed by magnetic closures (not shown) that keep door 12 sealed against a door jam (shown in FIG. 10).

Door 12 includes a top edge 22, a bottom edge 24, a left edge 26, and a right edge 28. Reversible handle 14 extends across a face surface 30 of door 12 in a first direction generally parallel with top edge 22 and bottom edge 24. Reversible handle 14 includes a grip 32 and a handle extension 34 that couples with center hinge 20. The grip is formed by a central region of a casting 74 and end sections of the casting provide handle coupling members 44 and 46. A connector plate 48 mechanically casting 74 to handle extension 34. A cover 36 overlies connector plate 48, and a noise piece 38 overlies handle coupling member 44 on the opposite side of the grip from the handle extension.

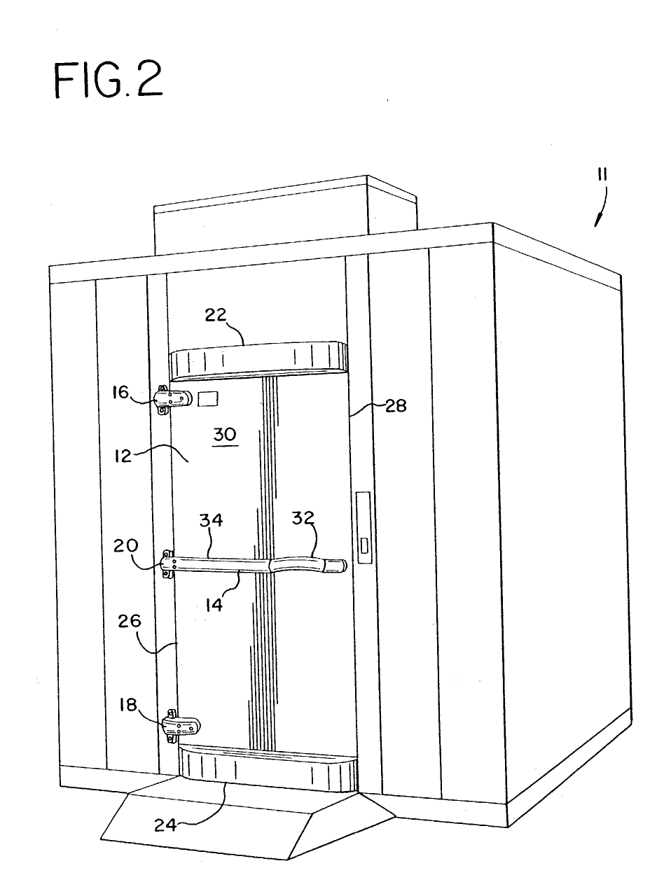

In the embodiment illustrated in FIG. 1, grip 32 is positioned in close proximity to left edge 26 of door 12. In an alternative embodiment illustrated in FIG. 2, grip 32 can be positioned in proximity to right edge 28 and hinges 16, 18 and 20 can be positioned to attach left edge 26 to walk-in cooler 10. As will subsequently by described, reversible handle 14 is constructed so as to enable its positioning for either right-hand or left-hand opening of a refrigerated compartment door. In particular, grip 32 is adapted to be coupled to handle extension 34 for either left-hand or right-hand opening of door 12.

The novel design features of reversible door handle 14 permits the handle to be mounted to a door, while maintaining the aesthetically pleasing appearance of the door handle. Accordingly, a walk-in cooler or other refrigeration unit can be constructed with either a right-hand or left-hand door to accommodate the positioning of walk-in cooler 10 in a variety of locations and in proximity to other equipment, while maintaining a common, aesthetically pleasing design, yet using one set of parts for both installation options.

FIG. 2 illustrates a perspective view of a walk-in cooler 111 having reversible handle 14 positioned for left-hand opening of door 30. Although, handle 14 is generally non-symmetrical, the individual components permit the handle to be shifted across face 30 without altering the overall shape and without providing dedicated left-hand and right-hand components.

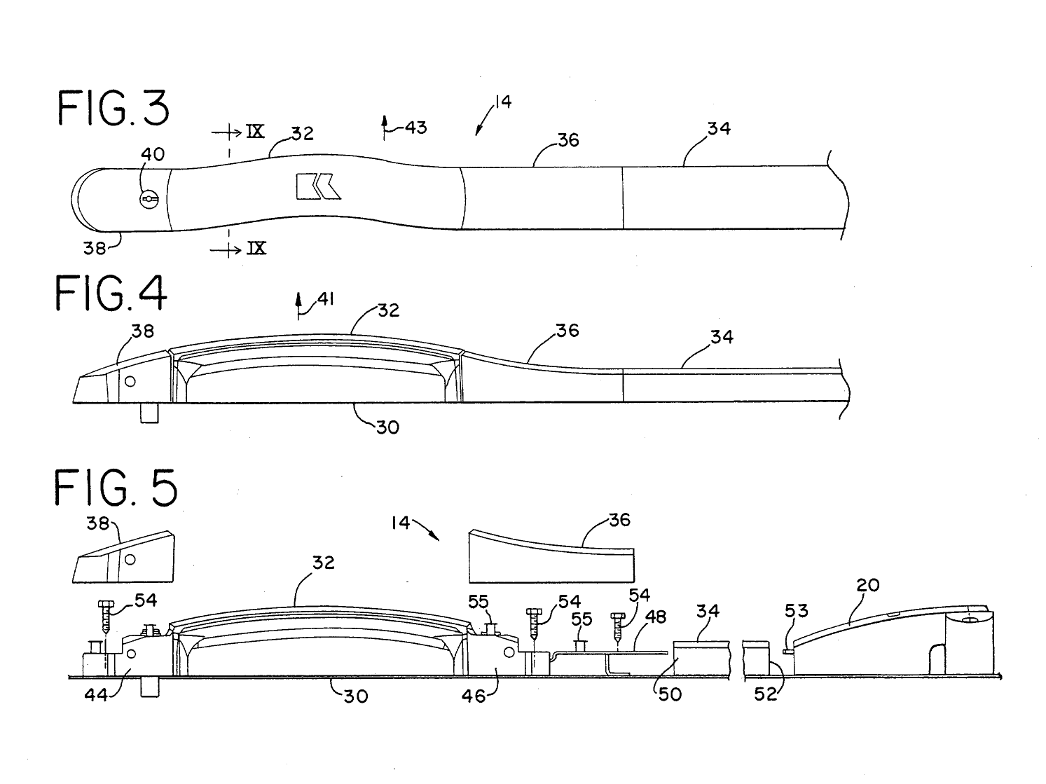

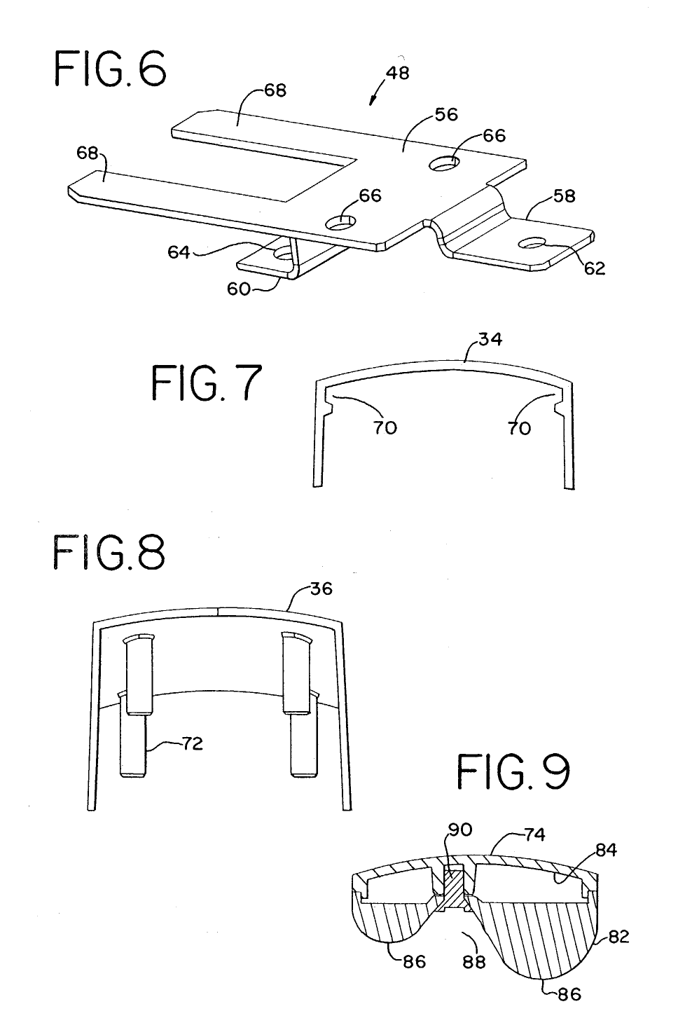

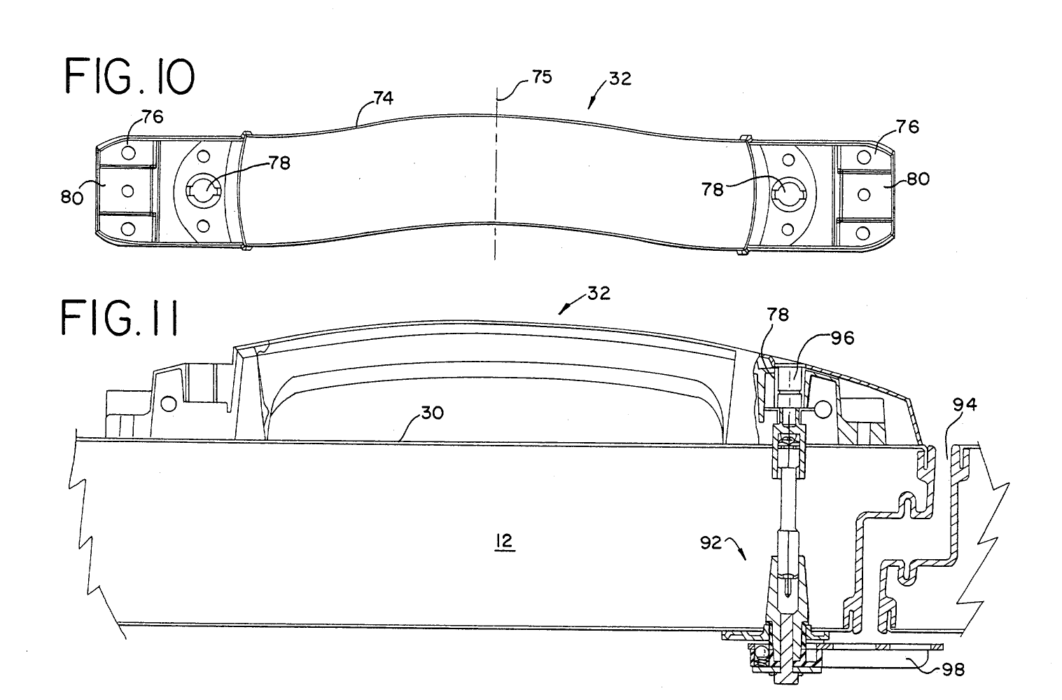

FIG. 3 illustrates a partial top view of reversible handle 14. Reversible handle 14 includes several components that contribute to both the reversible mounting capability and aesthetic design features. The top view of reversible handle 14 illustrated in FIG. 3 shows the covers for the various components of reversible handle 14. A cover plate 36 overlies a connector plate (shown in FIG. 6) and provides a smooth continuous surface between grip 32 and handle extension 34. A nose piece 38 extends from grip 32 opposite to cover plate 36. Nose piece 38 includes an opening 40 for access to a keyed latch (shown in FIG. 9). Grip 32 is shaped to enable reversible handle 14 to be easily grasped for opening and closing door 12.

A partial side view of reversible handle 14 is illustrated in FIG. 4. Grip 32 is raised in a second direction 41 away from face surface 30 of door 12. Referring back to FIG. 3, grip 32 is also raised in a third direction 43 toward top edge 22 of door 12. Second direction 41 is generally orthogonal to third direction 43. The shape of grip 32 facilitates easy grasping of the grip for opening and closing a walk-in cooler or freezer door. Further, the covers overlying the various components of reversible handle 14 abut against one another to form a smooth, continuously-flowing design characterized by oblique angles. By minimizing sharp edges and severe right angles, reversible handle 14 maintains a smooth aesthetically pleasing appearance, while providing an easily accessed grip for opening and closing door 12.

FIG. 5 illustrates a partial assembly view of reversible handle 14. Grip 32 is positioned between handle coupling members 44 and 46. A connector plate 48 is coupled to a first end 50 of elongated handle extension 34 and to handle coupling member 46. A second end 52 of elongated extension 34 is connected to center hinge 20. A tongue 53 protrudes from center hinge 20 for coupling with second end 52 of extension 34. In the embodiment illustrated in FIG. 5, handle coupling members 44 and 46 and connector plate 48 are attached to face surface 30 of door 12 by sheet metal screws 54. Fasteners 55 secure cover plate 36 to connector plate 48. Other screws 54 attach handle coupling member 44 to face surface 30 and other fasteners 55 secure noise piece 38 to handle coupling member 44. Those skilled in the art will, however, appreciate that the coupling members and connector plate can be attached to door 12 by a variety of attachment devices, including rivets, bolts, welds, adhesives, and the like.

A perspective view of connector plate 48 is illustrated in FIG. 6. In the illustrated embodiment, connector plate 48 is shaped in the form of a bracket having a first tongue 56, a second tongue 58, and a third tongue 60. Second tongue 58 is configured to couple with handle coupling member 46 by means of an opening 62 through which screw 54 inserts to engage face surface 30. Third tongue 60 includes an opening 64 through which screw 54 inserts to attach connector plate 48 to face surface 30. First tongue 56 also includes openings 66 through which fasteners 55 insert.

In the embodiment illustrated in FIG. 6, first tongue 56 is bifurcated into a pair of arms 68 that engage handle extension 34. A cross-sectional view of handle extension 34 is illustrated in FIG. 7. Extension 34 includes channel 70 formed on an inner surface of handle extension 34. Arms 68 of connector plate 48 slidably engage with channel 70 of extension 34 at first end 50. Correspondingly, tongue 53 of center hinge 20 slidably engages with channel 70 at second end 52 of extension 34. Through the engagement of connector plate 48 and center hinge 20 with handle extension 34, handle extension 34 is held in place against face surface 30. Those skilled in the art will appreciate that the attachment method illustrated herein is only one of many different mechanical arrangements for securing handle extension 34 to face surface 30. For example, rivets, bolds, adhesives, fasteners, and the like, can also be used to couple handle extension 34 to the components of reversible handle 14 and to face surface 30.

An end view of cover plate 36 is illustrated in FIG. 8. Cover plate 36 includes a plurality of studs 72 that engage fasteners 55 to hold cover plate 36 in place on handle coupling member 46 and connector plate 48. Those skilled in the art will recognize that cover plate 36 can be secured to the components of reversible handle 14 by various methods in addition to that illustrated herein. For example, cover plate 36 can be attached by means of screws, rivets, adhesives, welds, and the like.

A top view of a casting 74 for grip 32 is illustrated in FIG. 9. In accordance with the invention, casting 74 is symmetrically formed about a plane 75, such that grip 32 can be shifted to either side of a door to accommodate both a left-hand and a right-hand opening door. Accordingly, casting 74 includes two sets of openings 76 through which fasteners, and the like, can be inserted for attaching cover members to casting 74. Further, casting 74 includes openings 78 at each end for insertion of a door locking mechanism. Casting 74 also includes symmetrically disposed seat regions 80 at each end of the castings. Seat regions 80 accommodate second tongue 58 of connector plate 48 and permit alignment of opening 62 in second tongue 58 with center opening 76 in seat region 80. By providing symmetrically arranged openings at both ends of casting 74, casting 74 can be shifted to either side of a door without the need to invert the casting. Further, the symmetrical construction of casting 74 eliminates the need to provide a separate casting for right-hand and left-hand opening doors.

To further facilitate the use of reversible handle 14 for either a right-hand or left-hand door, connector plate 48 can easily be rotated 180° on face surface 30 to facilitate attachment of extension 34 and cover plate 36. Accordingly, the present invention enables reversible handle 14 to readily be mounted for right-hand or left-hand opening, while maintaining the non-symmetrical and aesthetically pleasing characteristics of the door handle.

A cross-sectional view of grip 32 is illustrated in FIG. 9. A plate 82 is attached to a back surface 84 of casting 74. Plate 82 has two lobed regions 86 separated by a valley 88. Lobe regions 86 project toward face surface 30 and, in combination with valley 88, form a grasping region of grip 32. Plate 82 is shaped so as to permit a user's fingers to rest in valley 88 when grasping grip 32. Plate 82 is attached to back surface 84 of plate 74 by a fastener 90. Faster 90 can be a screw, rivet, pin, and the like.

FIG. 11 illustrates a partially cutaway side view of grip 32 mounted to face surface 30. FIG. 11 also illustrates a cross-sectional view of door 12, including a locking mechanism 92 and door jam 94. Locking mechanism 92 includes a key cylinder 96 and lock handle 98. As described above, handle coupling members 44 and 46 and casting 74 have openings to accommodate keying cylinder 96 at either end of grip 32. Accordingly, keying cylinder 96 and lock handle 98 can be easily installed for either left-hand or right-hand opening doors. Noise piece 36 covers up the opposite opening 78 that is not being used. In accordance with the invention, connector plate 48 is readily attached to the handle coupling member opposite grip 32 from keying cylinder 96.

Thus, it is apparent that there has been described, in accordance with the invention, a reversible door handle that fully meets the advantages set forth above. Although the invention has been described and illustrated with reference to specific illustrative embodiments thereof, it is not intended that the invention be limited to those illustrative embodiments. Those skilled in the art will recognize that variations and modifications can be made without departing from the spirit of the invention. For example, the reversible handle can be used with a wide variety of doors other than doors for food chilling compartments, freezers, and the like. Further, the outward shape of the door handle can vary, depending upon the particular type of door to which the handle is used. For example, the width, length, curvature, and outward surface features can be altered from the embodiments illustrated herein. It is therefore intended to include within the invention all such variations and modifications as fall within the scope of the appended claims and equivalents thereof.

1. A reversible handle for a door having parallel left and right door edges, the handle comprising:
a) a grip generally perpendicular to the left and right door edges spanning between two handle coupling members, the grip reversibly positionable in proximity to either the left or right door edges;
b) a handle extension; and
c) a connector plate connecting a first end of the handle extension to an adjacent one of the two handle coupling members,
wherein the handle extension extends away from the connector plate in a direction generally opposite the grip.

2. The reversible handle of claim 1 wherein the handle coupling members are disposed in a first direction and wherein the grip comprises a raised section disposed in a second direction orthogonal to the first direction, such that a user's fingers can grip thereunder.

3. The reversible handle of claim 2 wherein the raised section is also disposed in a third direction generally orthogonal to the first and second directions.

4. The reversible handle of claim 2 wherein the raised section comprises an arch-shaped member extending between the two handle coupling members.

5. The reversible handle of claim 2 wherein the raised section further comprises a back surface adjacent to the door, and wherein the back surface comprises two lobed regions projecting toward the door and forming a valley therebetween, such that a user's finger tips rest in the valley when grasping the grasping member.

6. The reversible handle of claim 1 wherein the grip and the two handle coupling members comprise a monolithic member and wherein the reversible handle further comprises a cover overlying an outer surface of the monolithic member.

7. The reversible handle of claim 1 wherein the connector plate comprises a bracket having a first tongue engaging the handle extension, a second tongue connected to the adjacent one of the two handle coupling members, and a third tongue connected to the door.

8. The reversible handle of claim 7 wherein the handle extension further comprises channels in an inner surface thereof and wherein the first tongue comprises at least one arm that slidably engages the channels of the handle extension.

9. The reversible handle of claim 8 wherein the first tongue comprises a pair of arms.

10. The reversible handle of claim 1 further comprising a cover overlying an outer surface of the connector plate and the adjacent one of the two handle coupling members.

11. The reversible handle of claim 1 further comprising a locking apparatus located one of the two handle coupling members.

12. The reversible handle of claim 11 wherein the locking apparatus is located in one of the two handle coupling members opposite the connector plate.

13. The reversible handle of claim 12 further comprising a cover overlying an outer surface of the one of the two handle coupling members opposite the connector plate.

14. The reversible handle of claim 1 wherein a second end of the handle extension couples with a door hinge and is connected to a cover overlying the door hinge.

15. The reversible handle of claim 14 wherein the second end of the handle extension is connected to the cover by at least one tongue projecting from the cover and slidably engaging the channels of the handle extension.

16. A reversible door pull handle mounted on a walk-in cooler door comprising:
a) an elongated grip extending in a first direction on the door;
b) an elongated handle extension traversing the door in the first direction; and
c) a connector plate configured to position the elongated grip in either a first handle location or a second handle location, and
d) wherein the second handle location is along the first direction and on a side of the door opposite to the first handle location.

17. The reversible door pull handle of claim 16, wherein the grip further comprises first and second coupling members integral with and flanking the elongated grip.

18. The reversible door pull handle of claim 16 wherein the elongated handle extension comprises first and second ends, and wherein the first end is coupled to a connector plate and the second end is coupled to a door hinge wherein the connector plate comprises a first tongue engaging the elongated handle extension, a second tongue coupled to the grip, and a third tongue adapted for coupling to the door.

19. The reversible door pull handle of claim 16 wherein the elongated grip comprises an arched member extending outward from a face surface of the door and upward toward a top edge of the door.

20. The reversible handle of claim 19 wherein the arched member further comprises a back surface adjacent to the face surface, and wherein the back surface comprises two lobed regions projecting toward the face surface and forming a valley therebetween, such that a user's finger tips rest in the valley when grasping the elongated grip.

21. The reversible handle of claim 16 further comprising covers overlying the, the elongated grip, the connector plate, and the elongated handle extension, wherein the covers are characterized by smoothly flowing oblique curves.

22. A reversible handle for a left-hand or right-hand door, the handle comprising:
a) a grip reversibly positionable on the door for either left-hand or right-hand door operation;
b) a handle extension; and
c) a connector plate coupling a first end of the handle extension to the grip,
d) wherein the grip includes a member having similar structures at each end thereof for coupling the connector plate to either end of the grip.

23. The reversible handle of claim 22 wherein the structures comprise holes for fasteners and a seat for accommodating a portion of the connector plate.

24. The reversible handle of claim 22 wherein the grip comprises an arched member extending outward from a face surface of the door and upward toward a top edge of the door.

25. The reversible handle of claim 22 wherein the arched member further comprises a back surface adjacent to the door, and wherein the back surface comprises two lobed regions projecting toward the door and forming a valley therebetween, such that a user's finger tips rest in the valley when grasping the grasping member.

26. In combination a walk-in cooler having a door closing an opening into the walk-in cooler and a reversible door pull handle mounted on door, the reversible handle comprising:
a) an arched grip elongated in a first direction and extending outward from a face surface of the door and upward toward a top edge of the door; and
b) an elongated handle extension traversing the door in the first direction and coupled to the arched grip,
d) wherein the arched grip and the elongated handle extension are configured to position the arched grip in either a first handle location or a second handle location,
e) wherein the second handle location is along the first direction and on a side of the door opposite to the first handle location.

27. The combination of claim 26 wherein the arched grip and elongated handle extension comprise an integral feature having continuous upper and lower edges and wherein a distance between the upper and lower edges is constant across the face surface of the door.

28. The combination of claim 26 further comprising a connector plate coupling arched grip to the elongated handle extension and having a first tongue engaging the elongated handle extension, a second tongue coupled to the arched grip, and a third tongue adapted for coupling to the door.

29. In combination a door handle mounted on a door of a food-chilling compartment, the door handle comprising a grip and a handle extension that form a continuous lateral member across a face surface of the door, the lateral member having upper and lower edges that are a constant distance apart across the face surface of the door and wherein the grip bends in a first direction away from the face surface of the door and in a second direction toward an upper edge of door.

30. The combination of claim 28 wherein the grip and extension have the same appearance on the door regardless of whether the grip in located near a left edge of the door or a right edge of the door.

31. The combination of claim 28 further comprising a connector plate that couples the a grip and a handle extension to the door wherein the handle extension, the grip, and the handle extension are configured to position the grip in either a first handle location or a second handle location.
